(19) United States
(12) Patent Application Publication
(10) Pub. No.: US 2019/0201927 A1
(43) Pub. Date: Jul. 4, 2019

(54) ELECTROSTATIC SPRAYER

(71) Applicant: E-MIST INNOVATIONS, INC., Fort Worth, TX (US)

(72) Inventor: Michael L. Sides, Fort Worth, TX (US)

(73) Assignee: E-MIST INNOVATIONS, INC., Fort Worth, TX (US)

(21) Appl. No.: 16/234,294

(22) Filed: Dec. 27, 2018

Related U.S. Application Data
(60) Provisional application No. 62/612,135, filed on Dec. 29, 2017.

(51) Int. Cl. B05B 12/00; B05D 1/04; B05B 5/025

(52) U.S. Cl. CPC B05B 12/004; B05B 5/025; B05D 1/04

(57) ABSTRACT

Various components of a spraying system are provided. The spraying system may have a spraying module to accelerate a spray media toward a target and a controllable charging module to impart an electrostatic charge to the spray media. The electrostatic charge imparted to spray media may be changed over time by the controllable charging module. In this manner, characteristics of spray media in flight and arriving at a target may be controlled.

### CROSS-REFERENCE TO RELATED APPLICATION

This application claims priority to, and the benefit of, U.S. Provisional Patent Application Ser. No. 62/612,135 entitled “ELECTROSTATIC SPRAYER,” filed on Dec. 29, 2017, and naming Michael L. Sides as inventor, the content of which is hereby incorporated herein by reference in its entirety for any purpose.

### FIELD

The present disclosure relates to an electrostatic sprayer and more particularly, an electrostatic sprayer with a controllable charging module.

### BACKGROUND

Electrostatic sprayers are used to provide an electrical potential difference between charged particles and a target device. However, in many instances, an electrostatic charge accumulates on the electrostatic sprayer. Frequently, a grounding lead connects to an electrostatic sprayer, to an operator, or to an operator's clothing to dissipate this accumulation of charge. However, such spraying is frequently desired to be performed with relative mobility. Moreover, in many instances an electrostatic charge accumulates on the target surface to which the particles are sprayed. In many instances, such accumulation of charge diminishes the electrical potential difference between arriving charged particles and the target surface, diminishing the attraction and adherence of particles to the surface.

### SUMMARY

A spraying system is provided. The spraying system may include a spraying module and a controllable charging module. The spraying module may be configured to provide spray media and may have a charging array. The controllable charging module may be configured to electrically charge the charging array according to a driving waveform to electrostatically charge the spray media. In various instances, the controllable charging module selects a driving waveform to control at least one of a charge magnitude and a charge polarity of the spray media.

The spraying system may also have a spray media source. The spray media source may be a reservoir for spray media in mechanical communication with and supported by the spraying module as a self-contained unit.

The spraying system may have a spray media acceleration module. The spray media acceleration module may impart motion to the spray media and eject the spray media from the spraying module. Moreover, the spray media acceleration module may be a pump. In further instances, the spray media may be a fan. The spray media acceleration module may be at least one of a pump and a fan.

In various embodiments of the spraying system, the controllable charging module selects the driving waveform electrostatically charging the spray media at a first time to control the at least one of the charge magnitude and the charge polarity of the spray media at a second time after the first time. The second time may be a moment of contact of the spray media to the target.

The spraying system may include a body sense connection. The body sense connection may be an electrical connection of the spraying module to a sensor of the controllable charging module. The sensor may measure an electrical potential of the spraying module.

The spraying system may include a media sense connection. The media sense connection may be an electrical connection of the spray media passing through the spray media acceleration module to a sensor of the controllable charging module. The sensor may measure an electrical potential of the spray media.

The spraying system may include both a media sense connection and a body sense connection. The media sense connection may be an electrical connection of the spray media passing through the spray media acceleration module to a sensor of the controllable charging module. The body sense connection may be an electrical connection of the spraying module to the sensor of the controllable charging module. The sensor may measure a current flowing at least one of (a) into or (b) out of at least one of (i) the spray media connection and (ii) the body sense connection. The controller of the charging module may determine an amount of electrostatic charge imparted to the spray media based on the current.

The charging array of the spraying system may include an electrical conductor. The electrical conductor may provide at least a portion of a pathway of the spray media in transit from the spray media source through the spray media acceleration module. The charging array may be connected to a driver of the controllable charging module selectably configured to energize the charging array with the driving waveform.

The spraying system may have a controller. The controller may be processor operable to store and retrieve data from a target profile database, a velocity profile database, and a flight path profile database and operable to provide instructions to the driver responsive to the data. The target profile database may include instructions to shape the driving waveform based on at least one of (i) a dielectric constant of a target, (ii) a time constant of an electrostatic charge dissipation of the target, (iii) a porosity of the target, and (iv) a moisture content of the target. The flight path database may include instructions to shape the driving waveform based on at least one of (i) a time of flight of the spray media between the spraying module and the target, (ii) a charge amount of the target, (iii) an electrical potential of the target, (iv) a charge polarity of the target, and (v) a charge dissipation rate of the target.

In various instances of the spraying system, the driving waveform is shaped to cause the spray media to arrive at the target with a desired electrostatic potential difference between the spray media and the target and a desired electrostatic polarity relative to the target. In this manner the spray media is impelled to adhere to the target.

In various instances of the spraying system, the controllable charging module controls the driving waveform at a first time to cause the charge magnitude of the spray media to be within a first parameter at a second time corresponding to a moment of contact of the spray media to the target. The first parameter may be a target charge magnitude determined by the controller in response to the sensor. Moreover, the controllable charging module may control the charge polarity of the spray media within a first parameter at the instant of contact of the spray media to the target.

A method of spraying is provided. The method may include providing a spraying module configured to provide spray media and having a charging array. The method may also include providing a controllable charging module configured to electrically charge the charging array according to a driving waveform to electrostatically charge the spray media. Moreover, the method may include selecting, by the controllable charging module, a driving waveform to control at least one of a charge magnitude and a charge polarity of the spray media. In various embodiments of the method, the controllable charging module selects the driving waveform to control the at least one of the charge magnitude and the charge polarity of the spray media at an instant of contact of the spray media to the target.

Furthermore, the method may also include providing a spray media acceleration module to impart motion to the spray media and eject the spray media from the spraying module. The method may include providing a media sense connection including an electrical connection of the spray media passing through the spray media acceleration module to a sensor of the controllable charging module. There may also be provided a body sense connection including an electrical connection of the spraying module to the sensor of the controllable charging module. In various instances, the sensor measures a current flowing at least one of (a) into or (b) out of at least one of (i) the spray media connection and (ii) the body sense connection. A controller of the charging module determines an amount of electrostatic charge imparted to the spray media based on the current.

The method may include further aspects. For example, the method may include providing a spray media source. The spray media source may include a reservoir for spray media in mechanical communication with and supported by the spraying module as a self-contained unit. The charging array may include an electrical conductor providing at least a portion of a pathway of the spray media in transit from the spray media source through the spray media acceleration module. The charging array may be connected to a driver of the controllable charging module selectably configured to energize the charging array with the driving waveform. Finally, the controller may include a processor operable to store and retrieve data from a target profile database, a velocity profile database, and a flight path profile database and operable to provide instructions to the driver responsive to the data.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 depicts a spraying system in connection with spray media in flight along a flight path and in connection with a target having accumulated spray media, in accordance with various embodiments;

FIG. 2A depicts a neutral driving waveform of a spraying system, in accordance with various embodiments;

FIG. 2B depicts a positive buildup correction driving waveform of a spraying system, in accordance with various embodiments;

FIG. 2C depicts a negative buildup correction driving waveform of a spraying system, in accordance with various embodiments;

FIG. 3A depicts an example embodiment of a spraying system including a handheld application device, in accordance with various embodiments; and

FIG. 3B depicts an example embodiment of a spraying system including a remote application device, in accordance with various embodiments.

### DETAILED DESCRIPTION

The detailed description of exemplary embodiments herein refers to the accompanying drawings, which show exemplary embodiments by way of illustration and their best mode. While these exemplary embodiments are described in sufficient detail to enable those skilled in the art to practice the inventions, it should be understood that other embodiments may be realized and that logical, chemical and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented.

Various aspects of the disclosure herein may be implemented in combination to establish an electrostatic mist sprayer system, method, and apparatus. In general, electrostatic charging of matter creates an imbalance of electrons on the charged matter by either adding or subtracting electrons from matter, charging the matter. In various instances, electrostatic charge accumulates via the physical movement of charged ions from one place to another. An ion is an electrically charged atom or group of atoms associated with a loss or gain of one or more electrons. An ion may be negatively charged, having one or more extra electron, or may be positively charged, having one or more fewer electron.

In various instances, a device may be implemented to spray electrostatically charged matter toward a target object so that the electrostatically charged matter is attracted and/or adhered to the target object. Electrostatic charging devices provide an electrical potential difference between the charged matter and the target object. In various instances, an electrostatic charging device emits charged matter of one polarity, creating either positive or negatively charged matter. In the charging of the matter, electrons are added to or removed from the matter, such that a corresponding conjugate charge accumulates on the electrostatic charging device.

As discussed herein, an electrostatic charging device, in various embodiments, may include a controlled bipolar discharge of matter, meaning that the matter may alternately be charged positively and negatively, according to a desired driving waveform. The shape of the waveform may be selected in response to the distance between the electrostatic charging device and the target, the velocity of the electrostatically charged matter in flight to the target, the voltage and current characteristics of the electrostatic charging device, and the measured behavior of the target and the electrostatic charging device. Moreover, the charging waveform may include a series of charging pulses of positive, negative, or positive and negative polarity relative to a reference, the frequency, pulse width, spacing, and other characteristics of which may be selected to enhance the potential difference between the emitted charged matter and the target at the point of contact of the emitted charged matter to the target.

For instance, a target may exhibit an accumulated charge, which may have a polarity and may dissipate or increase over time. Thus, changes to the charging waveform may enhance maintenance of a desired potential difference between the target and each quantity of emitted charged spray media as it reaches the target.

Furthermore, the aforementioned aspects of the charging waveform may be selected to diminish charge accumulation on the electrostatic mist sprayer and/or its operator, such as by balancing the accumulation of positive and negative charge over time. Thus, it may be said that the electrostatic charging system is configurable to enhance accumulation/adhesion of spray media to a target and further ameliorate electrostatic mist sprayer ion imbalance.

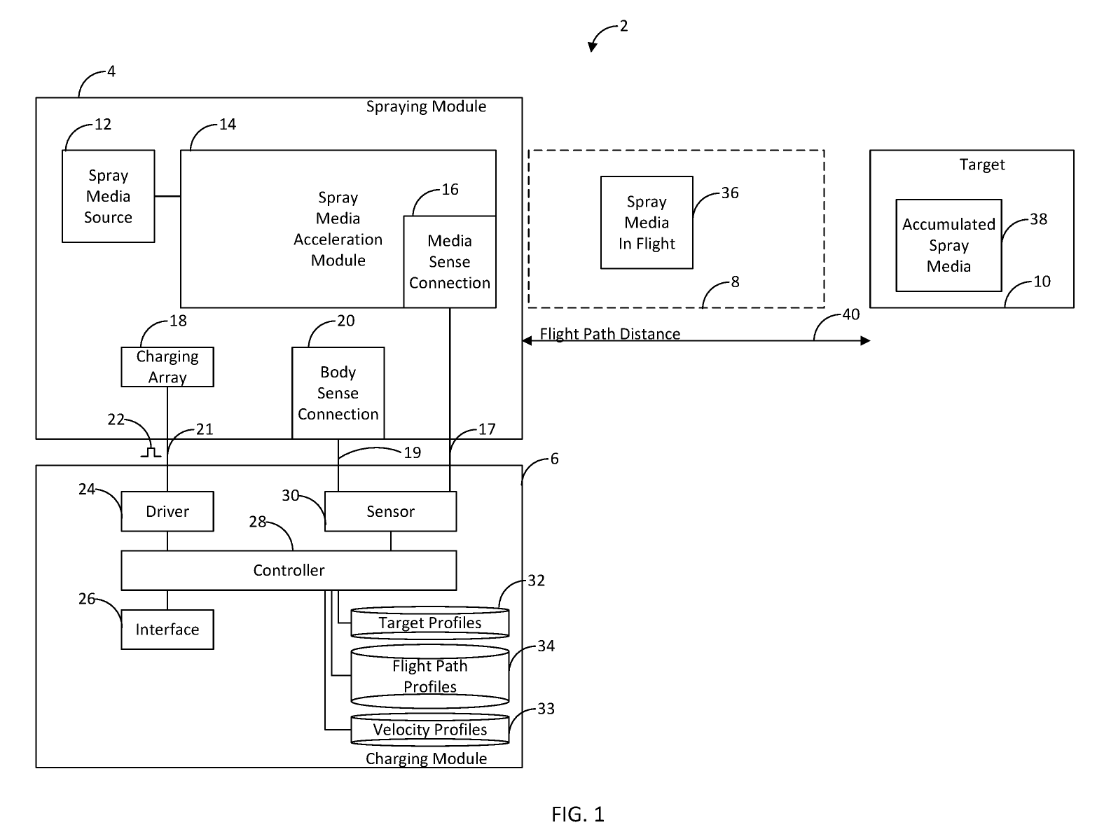

With reference to FIG. 1, a spraying system 2 is depicted in connection with spray media in flight 36 along a flight path 8 and in connection with a target 10 having accumulated spray media 38. A spraying system 2 may include a spraying module 4 configured to accelerate spray media toward a target 10 and a controllable charging module 6 configured to impart an electrostatic charge to the spray media in flight 36. In this manner, electrostatically charged spray media may contact the target 10 and accumulate thereon as accumulated spray media 38.

The spraying module 4 may include various aspects configured to project the spray media from the spraying system 2 and interoperate with a controllable charging module 6 to impart an electrostatic charge thereon. For instance, a spraying module 4 may include a spray media source 12. A spray media source 12 may comprise a reservoir of spray media for acceleration by other aspects of the spraying module 4 such as a spray media acceleration module 14. In various embodiments, the spray media source 12 may comprise a reservoir in mechanical communication with and supported by the spraying module 4 as a self-contained unit. In further embodiments, the spray media source 12 may comprise a remotely disposed reservoir connected to the spraying module 4. For example, there may be a remotely disposed reservoir connected by a pathway such as a conduit, tubing, or any other mechanism whereby spray media may be conveyed from a place of storage to aspects of the spraying module 4 such as the spray media acceleration module 14.

In various embodiments, the spraying module 4 may include a spray media acceleration module 14. A spray media acceleration module 14 may comprise an aspect configured to impart motion to spray media, ejecting it from the spraying module 4 as spray media in flight 36. In various instances, the spray media acceleration module 14 may comprise a fan, pump, piston, spinning cage, impeller, and/or any other translational or rotational velocity imparting apparatus.

The spraying module 4 may include a body sense connection 20. A body sense connection 20 may comprise an electrically conductive feature in electrical communication with the spraying module 4 and configured to connect electrically the spraying module 4 to an aspect of a controllable charging module 6, such as a sensor 30. In this manner, the electrical potential of an aspect of the spraying module 4 may be monitored. For example, a spraying module 4 may comprise a handheld device configured to accelerate spray media toward a target 10 as directed by a user holding the spraying module 4. A body sense connection 20 may detect the electrical potential of the handheld device.

Moreover, the spray media acceleration module 14 mentioned above may further comprise a media sense connection 16. A media sense connection 16 may comprise an electrically conductive feature in electrical communication with the spray media acceleration module 14 and/or in electrical communication at least momentarily with spray media passing through the spray media acceleration module 14 and/or passing from the spray media acceleration module 14 in route to a flight path 8 prior to or contemporaneously with the spray media becoming spray media in flight 36. The media sense connection 16 may be configured electrically to connect the spray media and/or spray media acceleration module 14 to an aspect of a controllable charging module 6, such as the sensor 30. In this manner, the electrical potential of an aspect of the spray media and/or spray media acceleration module 14 may be monitored. For example, a potential difference between the body sense connection 20 and the media sense connection 16 may be measured and/or a current flowing into or out of the body sense connection 20 and/or the media sense connection 16 may be measured to determine an amount of electrostatic charge imparted to spray media such as spray media in flight 36.

Finally, the spraying module 4 may include a charging array 18. A charging array 18 comprises an electrically conductive feature in electrical communication with the spray media acceleration module 14 and/or in electrical communication at least momentarily with spray media passing through the spray media acceleration module 14 and/or passing from the spray media acceleration module 14 in route to a flight path 8 prior to or contemporaneously with the spray media becoming spray media in flight 36. The charging array 18 may comprise an aspect of a nozzle of the spraying module 4 or other portion of a pathway of spray media in transit from a spray media source 12 through the spray media acceleration module 14 and/or prior to or contemporaneously with becoming spray media in flight 36.

Having discussed the spraying module 4 and the controllable charging module 6, attention is directed in detail to further aspects of the controllable charging module 6. In various embodiments, the controllable charging module 6 comprises a driver 24. A driver 24 comprises an electronic circuit configured selectably to energize the charging array 18 of the spraying module 4 with a driving waveform 22 via a charging connection path 21. The driver 24 generates an electrical current and/or voltage having a driving waveform 22 selected by the controller 28. In this manner, a spray media passing from a spray media source 12 through aspects of the spraying module 4 may be electrostatically charged. Moreover, the charging connection path 21 may in various instances comprise a circuit board trace, or local wiring, or connection within a shared housing of the spraying system 2 containing both aspects of the spraying module 4 and the controllable charging module 6. In further instances, the charging connection path 21 may comprise a wire or cable whereby the controllable charging module 6 may be remote from the spraying module 4, such as carried in a pack while the spraying module 4 is hand-held, or not carried by an operator but installed as a fixture in a location, such as a spray booth, or a product manufacturing facility, and/or the like.

The controllable charging module 6 may include a controller 28, as mentioned. The controller 28 may comprise a processor operable to receive instructions such as from an interface 26 and/or a sensor 30. The processor may be operable to store and retrieve data, such as from target profile database 32, velocity profile database 33, and flight path profile database 34. The processor may be operable to provide instructions, such as to a driver 24. In various embodiments, aspects of an example controller 28, an example sensor 30, and/or an example driver 24 may be integrated into a combined package. For example, there may be a bipolar high voltage DC-to-DC converter with active switched output provided. In various embodiments, a CHV0028 bipolar high voltage DC-to-DC converter with active switched output available from HVM Technology, Inc., may be implemented, though different configurations are contemplated.

The controllable charging module 6 may include a sensor 30. A sensor 30 may comprise a device configured to measure a current and/or a voltage. In various instances, a sensor 30 may compare a potential difference measured between the media sense connection 16 and the body sense connection 20 of the spraying module 4. In further instances, the sensor 30 may compare a potential difference of the media sense connection 16 and a reference and/or the body sense connection 20 and a reference. In further instances, the sensor 30 may measure a current flowing through a media sense connection 16 and/or a body sense connection 20.

The sensor 30 may further comprise a media sense connection signal path 17 comprising a circuit board trace, or local wiring, or connection within a shared housing of the spraying system 2 containing both aspects of the spraying module 4 and the controllable charging module 6. In further instances, the media sense connection signal path 17 may comprise a wire or cable whereby the controllable charging module 6 may be remote from the spraying module 4, such as carried in a pack while the spraying module 4 is hand-held, or not carried by an operator but installed as a fixture in a location, such as a spray booth, or a product manufacturing facility, and/or the like.

The sensor 30 may further comprise a body sense connection signal path 19 comprising a circuit board trace, or local wiring, or connection within a shared housing of the spraying system 2 containing both aspects of the spraying module 4 and the controllable charging module 6. In further instances, the body sense connection signal path 19 may comprise a wire or cable whereby the controllable charging module 6 may be remote from the spraying module 4, such as carried in a pack while the spraying module 4 is hand-held, or not carried by an operator but installed as a fixture in a location, such as a spray booth, or a product manufacturing facility, and/or the like.

The controllable charging module 6 may include an interface 26. An interface 26 may comprise a user interface whereby an operator may control the spraying system 2, such as changing aspects of a driving waveform 22. An interface 26 may further comprise a machine interface whereby an electronic device, such as an aspect of a production line of a factory may change aspects of a driving waveform 22.

Finally, the controllable charging module 6 may comprise one or more databases. For instance, in various embodiments, the controllable charging module 6 comprises a target profile database 32, a velocity profile database 33, and a flight path profile database 34. While depicted as separate databases herein, each may comprise a logical portion of a same database, such as different fields of a single database. In various instances, the controller 28 directs the driver 24 to produce a driving waveform 22 with certain characteristics chosen in response to data retrieved from at least one of the target profile database 32, velocity profile database 33, and flight path profile database 34.

In various instances, the target profile database 32 comprises instructions relating to target 10 and the shape of a driving waveform 22 to optimize the spray media in flight 36 to become accumulated spray media 38 on a target 10 having known characteristics, such as, for example, electrical characteristics such as dielectric constant and/or time constant related to electrostatic charge dissipation, or mechanical characteristics such as porosity, moisture content, and/or material composition, or environmental characteristics such as a desired saturation of accumulated spray media 38, and/or the like.

In various instances, the flight path profile database 34 may comprise instructions relating to the nature of a flight path 8, such as flight path distance 40 and the shape of a driving waveform 22 to optimize the spray media in flight 36 to become accumulated spray media 38 on a target 10 spaced apart from the spraying module 4 by a flight path 8. For instance, the flight path distance 40 may contribute to the time in flight of the spray media in flight 36 and thus contribute to the electrostatic charge, such as charge amount, electrical potential, charge polarity, charge dissipation rate, etc., of a target 10.

Similarly, the velocity profile database 33 may comprise instructions relating to the nature of the spray media in flight 36, such as the velocity and/or acceleration of the media leaving the spraying module 4, and/or transiting the flight path distance 40, and/or arriving at the target 10 as accumulated spray media 38, as well as the shape of the driving waveform 22, to optimize the spray media in flight 36 to become accumulated spray media 38 on a target 10. For instance, the velocity and/or acceleration of the media at various points in transit may contribute to the time in flight of the spray media in flight 36, as well as the dispersion of the spray media in flight 36, and may thus contribute to aspects of an electrostatic charge of a target 10, such as charge amount, electrical potential, charge polarity, charge dissipation rate, etc., of the target 10.

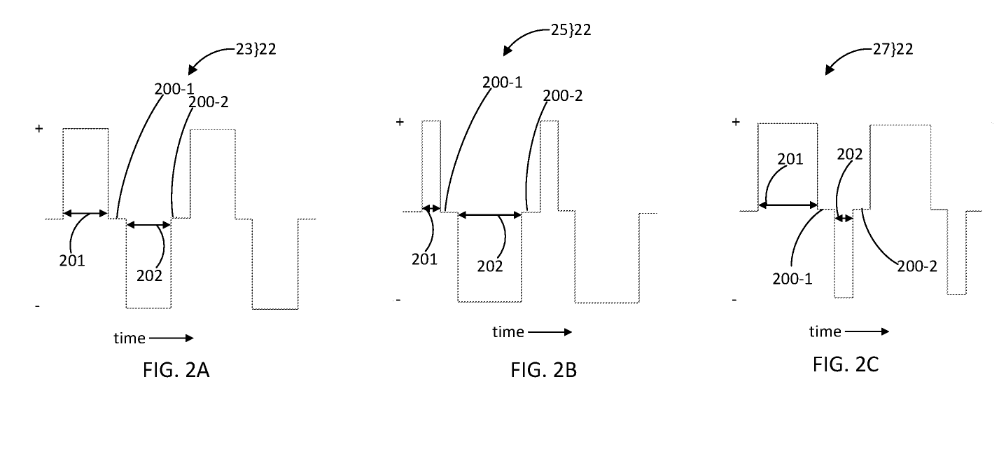

Continuing in reference to FIG. 1 but with additional reference to FIGS. 2A, 2B, and 2C, a variety of driving waveforms 22 are disclosed having various characteristics. As briefly mentioned, a driving waveform 22 may be chosen to cause the spray media in flight 36 to arrive at a target 10 with a desired electrostatic potential and electrostatic polarity such as to optimize the characteristics of incipient accumulated spray media 38 based on aspects of the target 10 and/or aspects of spraying system 2.

For example, it may be desirable periodically to change the polarity of the charging array 18 so that the spray media in flight 36 has different polarity at different times to ameliorate conjugate charge accumulation on aspects of the spraying system 2. However, because opposite charges attract and similar charges repel, it is necessary to also ensure that a sufficient potential difference is maintained between the target 10 with its accumulated spray media 38 and the spray media in flight 36 at the instant in time that spray media arrives at the target 10. Thus, aspects such as the flight path distance 40, the target profile data in the target profile database 32, the velocity of the spray media in transit, etc., are important to controlling the driving waveform 22 of the charging array 18.

A driving waveform 22 may comprise a sinusoidal wave, or triangular wave, a sawtooth wave, a square wave and/or a combination thereof. A driving waveform 22 may be amplitude modulated, frequency modulated, pulse-width modulated (PWM), and/or any combination thereof. One may appreciate that a driving waveform 22 may comprise any arbitrary waveform as desired.

With reference to FIG. 1 and FIG. 2A, various such driving waveforms 22 may comprise a neutral driving waveform 23. A neutral driving waveform 23 may have a positive peak width 201, a negative peak width 202, and delay times such as a first delay time 200-1 and a second delay time 200-2 having magnitudes, durations, and sequences chosen to ensure a desired potential difference between a target 10 with accumulated spray media 38 and spray media in flight 36 arriving at the target 10. In various instances, the positive peak width 201 comprises a width, in the time domain, of a positive going peak of an approximate square wave, and the negative peak width 202 may comprise a width, in the time domain of a negative going peak of an approximate square wave. In various instances, one or more delay time 200, such as a first delay time 200-1 and a second delay time 200-2 may separate the positive and/or negative going peak from the conjugate peak, such as to provide for a duty cycle of a square wave that is less than 100%. The delay time 200 such as first delay time 200-1 and second delay time 200-2 may provide an idle time between the positive peak width 201 and the negative peak width 202 with the positive peak width 201 and negative peak width 202 being equal width so as to cause equal amounts of positively and negatively charged spray media in flight 36 to be created over time.

With reference to FIG. 1 and FIG. 2B, various such driving waveforms 22 may comprise a positive buildup correction driving waveform 25. For instance, in response to a controller 28 determining based on sensor 30 and/or target profile database 32, velocity profile database 33, and/or flight path profile database 34 that an undesired excessive positive charge accumulation is building on a target 10, the controller 28 may direct the driver 24 to generate a driving waveform 22 comprising a positive buildup correction driving waveform 25. The positive buildup correction driving waveform 25 may comprise a positive peak width 201, a negative peak width 202, and delay times such as a first delay time 200-1 and a second delay time 200-2 having magnitudes, durations, and sequences chosen to ensure a desired potential difference between at target 10 with accumulated spray media 38 and a spray media in flight 36 arriving at the target 10. In various instances, the positive peak width 201 comprises a width, in the time domain, of a positive going peak of an approximate square wave, and the negative peak width 202 may comprise a width in the time domain of a negative going peak of an approximate square wave. In various instances, one or more delay time 200, such as a first delay time 200-1 and a second delay time 200-2 may separate the positive and/or negative going peak from the conjugate peak, such as to provide for a duty cycle of a square wave that is less than 100%. The delay time 200 such as first delay time 200-1 and second delay time 200-2 may provide an idle time between the positive peak width 201 and the negative peak width 202 with the positive peak width 201 being decreased in size relative to that of the neutral driving waveform 23 and/or the negative peak width 202 being increased in size relative to that of the neutral driving waveform 23, so as to case a greater amount of negatively charged spray media in flight 36 than positively charged spray media in flight 36 to be created over time.

With reference to FIG. 1 and FIG. 2C, various such driving waveforms 22 may comprise a negative buildup correction driving waveform 27. For instance, in response to a controller 28 determining based on sensor 30 and/or target profile database 32, velocity profile database 33, and/or flight path profile database 34 that an undesired excessive negative charge accumulation is building on a target 10, the controller 28 may direct the driver 24 to generate a driving waveform 22 comprising a negative buildup correction driving waveform 27. The negative buildup correction driving waveform 27 may comprise a positive peak width 201, a negative peak width 202, and delay times such as a first delay time 200-1 and a second delay time 200-2 having magnitudes, durations, and sequences chosen to ensure a desired potential difference between at target 10 with accumulated spray media 38 and a spray media in flight 36 arriving at the target 10. In various instances, the positive peak width 201 comprises a width, in the time domain, for a positive going peak of an approximate square wave, and the negative peak width 202 may comprise a width in the time domain of a negative going peak of an approximate square wave. In various instances, one or more delay time 200, such as a first delay time 200-1 and a second delay time 200-2 may separate the positive and/or negative going peak from the conjugate peak, such as to provide for a duty cycle of a square wave that is less than 100%. The delay time 200 such as first delay time 200-1 and second delay time 200-2 may provide an idle time between the positive peak width 201 and the negative peak width 202 with the positive peak width 201 being increased in size relative to that of the neutral driving waveform 23 and/or the negative peak width 202 being decreased in size relative to that of the neutral driving waveform 23, so as to case a greater amount of positively charged spray media in flight 36 than negatively charged spray media in flight 36 to be created over time.

Thus, with reference to FIGS. 1, 2A, 2B, and 2C, a spraying system 2 may include a spraying module 4 configured to provide spray media such as a spray media in flight 36 and having a charging array 18. The spraying system 2 may also include a controllable charging module 6 that is configured to charge the charging array 18 according to a driving waveform 22 to charge the spray media electrostatically, such as spray media in flight 36. In various instances, the controllable charging module 6 selects a driving waveform 22 to control at least one of a charge magnitude and a charge polarity of the spray media within a first parameter. The first parameter may be a target charge magnitude or target charge polarity determined by the controller 28 in response to the sensor 30 and the target profile database 32, velocity profile database 33, and flight path profile database 34 as well as in accordance with instructions from the interface 26, such that a driving waveform 22 is selected to achieve the first parameter. The first parameter may be a function of time and the value of the first parameter further may be path dependent.

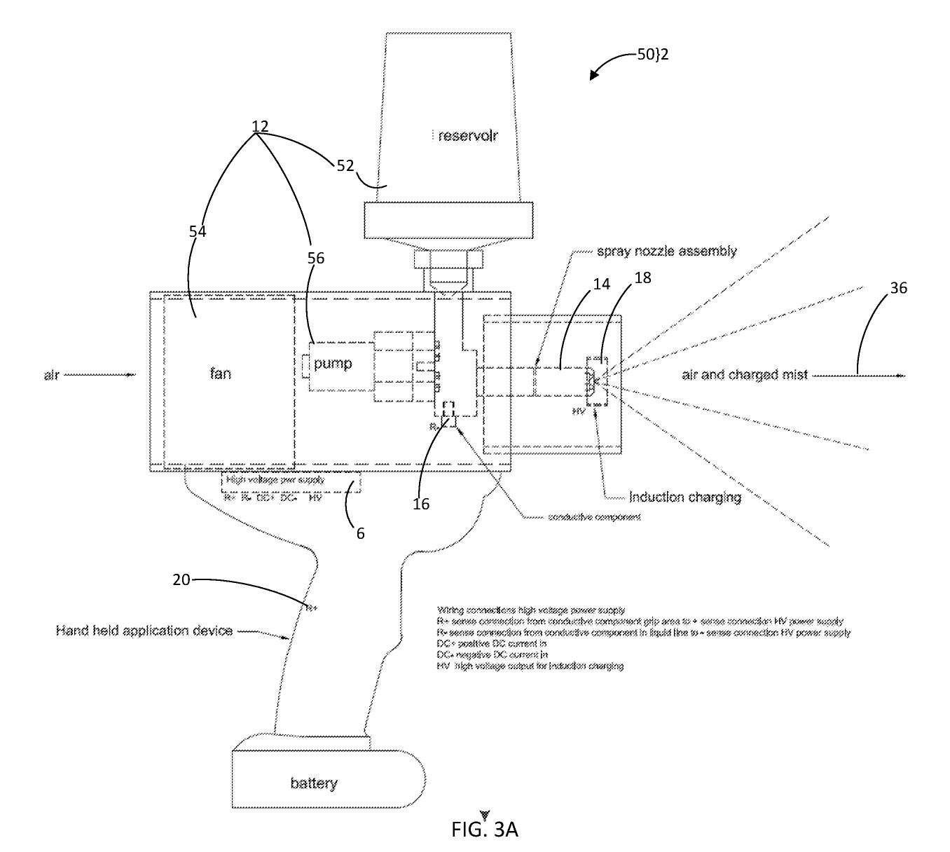

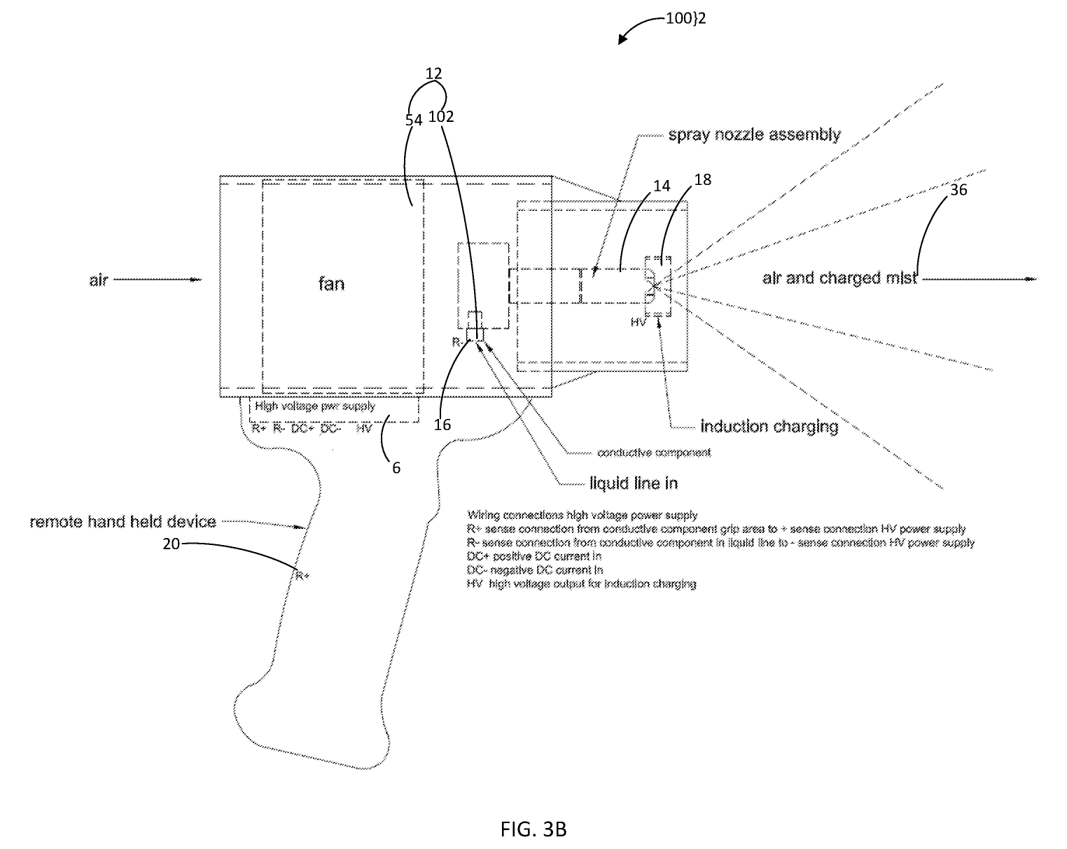

Having discussed various embodiments of a spraying system 2 generating various driving waveforms 22, attention is turned to FIG. 3A, in addition to ongoing attention to FIG. 1 and FIGS. 2A, 2B, and 2C. FIG. 3A shows an embodiment of a spraying system 2, and specific configurations of a spray media source 12, a charging array 18 a spray media acceleration module 14 with a media sense connection 16, and spray media in flight 36. Similarly, FIG. 3B shows an embodiment of a spraying system 2 and specific configurations of a spray media source 12, a charging array 18, a spray media acceleration module 14 having a media sense connection 16, and spray media in flight 36.

With specific emphasis on FIG. 3A, an embodiment of the spraying system 2 comprising a handheld application device 50 comprising a spray media source 12 disposed on the handheld application device 50. For instance, such a spray media source 12 may comprise a media reservoir 52, a fan 54, and a pump 56. A media reservoir 52 may comprise a container to receive a quantity of spray media. The pump 56 may draw spray media from the media reservoir 52 for ejection from the spray media acceleration module 14, and the fan 54 may impel the spray media toward a target 10.

Shifting focus from FIG. 3A to FIG. 3B, a further embodiment of a spraying system 2 comprising a remote application device 100 is depicted comprising a spray media source 12 comprising aspects disposed remotely from a handheld portion of the remote application device 100. For instance, the remote application device 100 does not include the media reservoir 52 but instead includes a media line in 102. A media line in 102 provides an input of spray media from a remote origin. The spray media source 12 also comprises a fan 54 configured to accelerate spray media received from the media line in 102 toward a target 10.

In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Any reference to singular embodiments includes plural embodiments, and any reference to more than one component or step may include a singular embodiment or step.

Phrases such as “make contact with,” “coupled to,” “in communication with,” “touch,” “interface with” and “engage” may be used interchangeably. As used herein, “logical communication” or “logical connection” may refer to any method by which information may be conveyed. Logical communication may facilitate the transmission of signals, whether analog or digital, between two or more components. Thus, “logical communication” may refer to any electrical, electromagnetic, radiofrequency and/or optical method whereby information may be conveyed. Finally, any reference to attached, fixed, connected or the like may include permanent, removable, temporary, partial, full and/or any other possible attachment option.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A spraying system comprising:
a spraying module configured to provide spray media and having a charging array; and
a controllable charging module configured to electrically charge the charging array according to a driving waveform to electrostatically charge the spray media,
wherein the controllable charging module selects a driving waveform to control at least one of a charge magnitude and a charge polarity of the spray media.

2. The spraying system according to claim 1, further comprising:
a spray media source comprising a reservoir for spray media in mechanical communication with and supported by the spraying module as a self-contained unit.

3. The spraying system according to claim 1, further comprising:
a spray media acceleration module to impart motion to the spray media and eject the spray media from the spraying module.

4. The spraying system according to claim 3, wherein the spray media acceleration module comprises at least one of a pump and a fan.

5. The spraying system according to claim 3, wherein the controllable charging module selects the driving waveform electrostatically charging the spray media at a first time to control the at least one of the charge magnitude and the charge polarity of the spray media at a second time after the first time, the second time comprising a moment of contact of the spray media to the target.

6. The spraying system according to claim 5, further comprising:
a body sense connection comprising an electrical connection of the spraying module to a sensor of the controllable charging module,
wherein the sensor measures an electrical potential of the spraying module.

7. The spraying system according to claim 5, further comprising:
a media sense connection comprising an electrical connection of the spray media passing through the spray media acceleration module to a sensor of the controllable charging module,
wherein the sensor measures an electrical potential of the spray media.

8. The spraying system according to claim 7, further comprising:
a body sense connection comprising an electrical connection of the spraying module to the sensor of the controllable charging module,
wherein the sensor measures an electrical potential of the spraying module.

9. The spraying system according to claim 5, further comprising:
a media sense connection comprising an electrical connection of the spray media passing through the spray media acceleration module to a sensor of the controllable charging module; and
a body sense connection comprising an electrical connection of the spraying module to the sensor of the controllable charging module,
wherein the sensor measures a current flowing at least one of (a) into or (b) out of at least one of (i) the spray media connection and (ii) the body sense connection; and
wherein a controller of the charging module determines an amount of electrostatic charge imparted to the spray media based on the current.

10. The spraying system according to claim 2,
wherein the charging array comprises an electrical conductor providing at least a portion of a pathway of the spray media in transit from the spray media source through the spray media acceleration module, and
wherein the charging array is connected to a driver of the controllable charging module selectably configured to energize the charging array with the driving waveform.

11. The spraying system according to claim 10, further comprising:
a controller comprising a processor operable to store and retrieve data from a target profile database, a velocity profile database, and a flight path profile database and operable to provide instructions to the driver responsive to the data.

12. The spraying system according to claim 11,
wherein the target profile database comprises instructions to shape the driving waveform based on at least one of:
(i) a dielectric constant of a target,
(ii) a time constant of an electrostatic charge dissipation of the target,
(iii) a porosity of the target, and
(iv) a moisture content of the target.

13. The spraying system according to claim 11, wherein the flight path database comprises instructions to shape the driving waveform based on at least one of:
(i) a time of flight of the spray media between the spraying module and the target,
(ii) a charge amount of the target,
(iii) an electrical potential of the target,
(iv) a charge polarity of the target, and
(v) a charge dissipation rate of the target.

14. The spraying system according to claim 10,
wherein the driving waveform is shaped to cause the spray media to arrive at the target with a desired electrostatic potential difference between the spray media and the target and a desired electrostatic polarity relative to the target, whereby the spray media is impelled to adhere to the target.

15. The spraying system according to claim 11,
wherein the controllable charging module controls the driving waveform at a first time to cause the charge magnitude of the spray media to be within a first parameter at a second time corresponding to a moment of contact of the spray media to the target, and
wherein the first parameter comprises a target charge magnitude determined by the controller in response to the sensor.

16. The spraying system according to claim 11, wherein the controllable charging module controls the charge polarity of the spray media within a first parameter at the instant of contact of the spray media to the target.

17. A method of spraying comprising:
providing a spraying module configured to provide spray media and having a charging array;
providing a controllable charging module configured to electrically charge the charging array according to a driving waveform to electrostatically charge the spray media; and
selecting, by the controllable charging module, a driving waveform to control at least one of a charge magnitude and a charge polarity of the spray media.

18. The method of spraying according to claim 17, wherein the controllable charging module selects the driving waveform to control the at least one of the charge magnitude and the charge polarity of the spray media at an instant of contact of the spray media to the target.

19. The method spraying system according to claim 17, further comprising:
providing a spray media acceleration module to impart motion to the spray media and eject the spray media from the spraying module;
providing a media sense connection comprising an electrical connection of the spray media passing through the spray media acceleration module to a sensor of the controllable charging module; and
providing a body sense connection comprising an electrical connection of the spraying module to the sensor of the controllable charging module,
wherein the sensor measures a current flowing at least one of (a) into or (b) out of at least one of (i) the spray media connection and (ii) the body sense connection, and
wherein a controller of the charging module determines an amount of electrostatic charge imparted to the spray media based on the current.

20. The method of spraying according to claim 17, further comprising:
providing a spray media source comprising a reservoir for spray media in mechanical communication with and supported by the spraying module as a self-contained unit,
wherein the charging array comprises an electrical conductor providing at least a portion of a pathway of the spray media in transit from the spray media source through the spray media acceleration module, and
wherein the charging array is connected to a driver of the controllable charging module selectably configured to energize the charging array with the driving waveform; and
providing a controller comprising a processor operable to store and retrieve data from a target profile database, a velocity profile database, and a flight path profile database and operable to provide instructions to the driver responsive to the data.
